(19) United States
(12) Patent Application Publication
(10) Pub. No.: US 2006/0167905 A1
(43) Pub. Date: Jul. 27, 2006

(54) Method and system for template data validation based on logical constraint specifications

(76) Inventors: Peiya Liu, East Brunswick, NJ (US); Liang H. Hsu, Irvine, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/199,909

(22) Filed: Aug. 9, 2005

Related U.S. Application Data
(60) Provisional application No. 60/647,718, filed on Jan. 27, 2005.

(51) Int. Cl. G06F 7/00

(52) U.S. Cl. 707/100

(57) ABSTRACT

A method and system to validate template data based on logical constraint specifications for constraining data collection in XML forms. The invention comprises methods and systems for validating dynamic, calculated, and other template data types. The constraint descriptions include data types, cardinality, order, co-occurrence, Boolean logic, read-only data, regular expression patterns, and others. The method of the invention immediately validates data upon entry based on constraint specifications without human interaction and enhances the efficiency of data collection.

### REFERENCE TO RELATED APPLICATION

This application claims the benefit of U.S. Provisional Application No. 60/647,718, filed on Jan. 27, 2005, which is incorporated herein by reference in its entirety.

### BACKGROUND

The invention relates generally to electronic data forms. More specifically, embodiments of the invention relate to methods and systems which validate extensible markup language (XML) template data for constraining data during entry in electronic forms.

Today, electronic forms are commonplace wherever data needs to be collected and documented. Interactive Web sites use these constructs to create interfaces ranging from surveys and questionnaires, to shopping applications. The most common example is a presentation of a form image on a computer display that allows a user to enter data that may be processed by a wide variety of processing applications.

Common to electronic forms are procedural extensions such as calculations, validations and event handling. The procedural descriptions of how values within a form are validated and calculated are among the central concepts that define a form.

A hypertext markup language (HTML) form is a section of a document containing content, markup, control elements (checkboxes, radio buttons, menus, etc.) and labels. A user typically completes a form by entering data (text, selecting menu items, etc.) before submitting the form to an agent for processing. With markup constructs that create input fields and other user interaction elements, Web sites, for example, are able to deploy Web pages that collect user input as simple name-value pairs. The data input by the user is transmitted via hypertext transfer protocol (HTTP) and processed usually on a server.

HTML forms provide an interface to standard transaction oriented applications. Web developers author client-side interfaces in HTML and create corresponding server-side logic that processes the submitted data before communicating it to the actual application. The combination of the HTML user interface and the server-side logic used to process the submitted data are referred to as the Web application. The Web application in turn communicates the user's information to the application, receives results, and embeds the results in an HTML page to create a user interface to be delivered as a server response to the user's Web browser. However, the simplicity of HTML forms results in scalability problems when developing complex applications.

User data obtained via HTTP is validated at the server within servlets or other server-side software. Performing such validation at the server after the user has completed the form results in an unsatisfactory end-user experience when working with complex forms—the user finds out about invalid input long after the value is provided. This can be overcome by inserting validation scripts into the HTML page. However, such scripts duplicate the validation logic implemented on the server side. This duplication often has to be repeated for each supported browser to handle differences in the Javascript environment.

Web applications need to be accessible from a variety of access devices and interaction modalities. Web applications may be accessed from a variety of clients ranging from desktop browsers to smart phones capable of delivering multimodal interaction. As a result, a travel application that is being deployed to the Web needs to be usable from within a desktop browser, a personal digital assistant (PDA), or a cell phone equipped with a small display. The interface needs to be usable when interacting via a graphical interface. The problems associated with HTML forms become greater when electronic transactions are performed using a variety of different end-user devices and user interaction modalities.

A Web application using electronic forms typically requires various software modules or components that would be authored on the client and server sides to deploy a complete end-to-end solution. Data collected by a form is communicated to an associated application that imposes various validity constraints on the data such as all requested data items presented on a form must be provided, the entered data must be appropriate for each field, and others.

The Web developer models the various items of data to be collected as name-value pairs. Compound data items like address and name are made up of subfields, and are modeled as simple string value pairs adding field names.

A server-side software component must be created that receives the submitted data as name-value pairs. This component produces the HTML page that is forwarded to the user generating the initial user interface and displays any default values. It receives submitted data as name-value pairs via HTTP, validates the received data to ensure that all application constraints are satisfied, and generates a new HTML page that allows the user to update the previously supplied values if necessary. The server-side component also makes all fields sticky such that user data is not lost during client-server communications, and also marshals the received data into a structure that is suitable for the back-end application when all fields have valid data since intermediate fields created by the Web developer such as name first may not match what the survey application expects, transmits the collected data to the back-end, processes the resulting response, and communicates the results to the user by generating an appropriate HTML page.

The user interface is delivered to the connecting browser by producing an appropriate HTML markup, and transmits the markup via HTTP to the user's browser. Interaction elements such as input fields are contained in an HTML element <form> that also specifies where the data is to be submitted using a universal resource identifier (URI), the HTTP method to use (for example, GET or POST), and details on the encoding to use when transmitting the data. HTML markup for user interface controls (for example, <input>) is used to create input fields in the resulting user interface. Markup refers to the field names defined earlier (for example, name.first), to specify the association between the field names defined by the Web developer and the values provided by the end user. The markup also encodes default values, if any, for the various fields.

Field names used in the HTML markup need to match the names used in the server-side component. Making all fields sticky requires that the previously received values be embedded in the generated HTML.

To achieve this, Web applications produce HTML markup from within the common gateway interface (CGI) script. This approach does not scale well when creating complex applications. This is because of the lack of separation of concerns that results from mixing user interface data with server-side application logic.

The lack of separation of concerns that arises when incorporating presentational markup within executable CGI scripts is overcome by developing Web applications using more sophisticated server-side technologies. To obviate this, the user interface is created as an XML document with special tags that invoke the appropriate software components when processed by the server. A simple Web application could be created as a set of software objects that implements the validation and navigation logic, and a set of markup pages used to generate the user interface at each stage of the interaction for a high-level overview of the resulting components and their interdependencies.

XML is a document description language similar to HTML; however, XML is much more versatile than HTML. HTML is used to create pages using a series of tags, which instructs the software reading it how to present the material. The software reading HTML is typically a browser. Like HTML, XML is a system of tags that describe components of a document. Both XML and HTML are subsets of standard generalized markup language (SGML).

HTML consists of a set of predefined tags and instructs the browser to perform certain operations with the document. Typically, the tags describe aspects of presentation, such as font, style, size, line spacing, etc. and also identify links to other pages, drawings, artwork, etc. HTML has its limitations since the tags are primarily concerned with the presentation of the data. It is not possible to use the tags to describe the data structure or in other ways to describe the contents of the document.

The extensible nature of XML allows users to define and create custom tags. Therefore, users can describe the structure and nature of the information presented in a document. The negative side is that the software environment for XML is more complex. XML documents must be well formed and in strict compliance with the rules specified in the document's corresponding document type definition (DTD) or schema. In other words, a vocabulary of a particular XML dialect is limited to what is defined in that dialect's dictionary.

Most services available on the Web exchange data in the form of XML messages. Depending upon the type of services provided, a unique schema typically accompanies the message. When a client calls upon a service, an XML data message is sent over a network and a response is returned to the client.

XML schema is a newer method for defining XML dialect than the older DTD specification. XML schema uses XML itself to create special documents called schema that describe the structure and syntax of a particular XML dialect. Hundreds of different dialects or schemas have been developed for different industry sectors.

A schema is a model for describing the structure of the exchanged information. For XML, a schema describes a model for a whole class of documents. The model describes the possible arrangement of tags and text in a valid document and can also be viewed as an agreement on a common vocabulary for a particular application that involves exchanging documents.

Schemas are used for analysis. For example, the following written in HTML/XML is a valid postal address

<address>
<name>Patrick Bateman</name>
<street>55 West Eighty-first Street</street>
<city>New York</city>
<state>NY</state>
<zip>10024</zip>
</address>

In schemas, models are described in terms of constraints. A constraint defines what can appear in any given context. There are basically two types of constraints: content model constraints describe the order and sequence of elements and data type constraints describe valid units of data.

For example, a schema might describe a valid <address> with the content model constraint that it consist of a <name> element, followed by one or more <street> elements, followed by exactly one <city>, <state>, and <zip> element. The content of a <zip> might have a further datatype constraint that it consist of either a sequence of exactly five digits or a sequence of five digits, followed by a hyphen, followed by a sequence of exactly four digits. No other text is a valid ZIP code.

The purpose of a schema is to allow machine validation of document structure. Every specific, individual document that does not violate any of the constraints of the model is, by definition, valid according to that schema. Using the schema described above, a parser would be able to detect that the following address is not valid.

<address>
<name>Patrick Bateman</name>
<street>55 West Eighty-first Street</street>
<city>New York</city>
<state>NY</state>
<state>NY</state>
<zip>red</zip>
</address>

It violates two constraints: it does not contain exactly one <state> and the ZIP code is not of the proper form.

The ability to test the validity of documents is an important aspect of large applications that are receiving and sending information to many sources. An address in schema notation would appear:

<elementType name=“address”>
<sequence>
<elementTypeRef name=“company” minOccur=“O” maxOccur=“1”/>
<elementTypeRef name=“name” minOccur=“ 1” maxOccur=“1”/>
<elementTypeRef name=“street” minOccur=“1” maxOccur=“2”/>
<elementTypeRef name=“city” minOccur=“1” maxOccur=“1”/>
<elementTypeRef name=“state” minOccur=“1” maxOccur=“1”/>
<elementTypeRef name=“zip” minOccur=“1” maxOccur=“1”/>
</sequence>
</elementType>

This element type is different from the preceding ones; it defines the content of the <address> element in terms of other elements. It begins with a <sequence>. A sequence indicates that the items inside the sequence must occur in the order given. Inside the sequence we see references to other element types. Each element type so referenced must have a corresponding <elementType> declaration.

Additionally, qualifiers indicate how often each element may occur. A minimum occurrence of zero makes the element optional. These indicators serve the same purpose as qualifiers in DTD syntax, but flexible since both minimum and maximum values may be specified.

Using XML, the information collected from the user is encapsulated in a structured XML document that suits the application. Compound data items are modeled to reflect the structure of the data, unlike using name-value pairs. This eliminates the need to introduce intermediate fields to hold portions of the user data and the subsequent need to marshal such intermediate fields into the structure required by the application.

The XML instance can be annotated with the various constraints specified by the application. For example, age should be a number. When using XML, such constraints are typically encapsulated in an XML schema document that defines the structure of the XML instance.

Complex schemas encapsulate more constraints, such as specifying the rules for validating a 9-digit Social Security Number or specifying the set of valid values for the various fields. The advantage of specifying such constraints using XML schema is that the developer can then rely on XML parsers to validate the data instance against the supplied constraints.

Although documents authored in XML have opened up new and more effective ways for data collection and document processing, traditional XML DTD or schema grammar-based methods have limitations in validating dynamic data or calculated fields. These types of data entries require a logic-based specification method for constraining non-static data. Most data collection applications require validating dynamic data in addition to static data in an efficient way.

Grammar-based methods are mainly used for validating document structures and static data. Dynamic data validations are used in application areas which require validation based on collected content beyond data types in grammar-based methods. For example, in a co-occurrence requirement, if field a has collected data x, then field b must have data y, or, a numeric comparison in the data collection fields such as if the value of field a is less than the sum of the values of fields b and c.

Achieving data validation in electronic forms has proven problematic most often due to the methods used to constrain user entered data. What is desired is a method for a logical constraint specification having a sequence of content and element attribute constraints written in XML for constraining data when entered in template-based electronic forms.

### SUMMARY

Although there are various methods and systems that perform data validation and constraints for electronic form fields, and maintain data relationships among different data fields, such methods and systems are not completely satisfactory. The inventors have discovered that it would be desirable to validate template data based on logical constraint specifications for constraining data collected in XML forms. The invention comprises methods and systems for validating dynamic, calculated, and other electronic form data types.

The method and system is based on formal logical constraint specifications. The constraint specifications include data types, cardinality, order, co-occurrence, Boolean logic, read-only data, regular expression patterns, and others. The method of the invention immediately validates input data upon entry based on constraint specifications without human interaction and enhances the efficiency of data collection.

One aspect of the invention provides methods for dynamically and progressively validating input data. Methods according to this aspect of the invention preferably start with receiving input data via an input form having an associated logical constraint specification, determining if the input data is associated with one or more constraints within the logical constraint specification, invoking one or more operators on the input data to generate one or more logical variables based on the logical constraint specification, combining the one or more logical variables based on the logical constraint specification into a single logical expression for validation, and validating the input data based on the single logical expression.

Another aspect of the invention is when determining if the input data is associated with one or more constraints within the logical constraint specification, selecting one or more data collection fields in the input form.

Another aspect of the invention is a system for dynamically and progressively collecting and validating electronic form input data. The system includes a template having data entry areas, a logical constraint specification having at least one data constraint for at least one of the template data entry areas, and a data collector and validator engine that performs data validation for data entered in the template data entry areas.

Other objects and advantages of the systems and methods will become apparent to those skilled in the art after reading the detailed description of the preferred embodiments.

### BRIEF DESCRIPTION OF THE DRAWINGS

FIG. 1 is a block diagram of an exemplary computer.

FIG. 2 is an exemplary framework of the individual modules of the invention.

FIG. 3 is an exemplary presentation of a form in view using logic constraint specifications and data validation according to an embodiment of the invention.

FIG. 4 is a block diagram of an exemplary method according to an embodiment of the invention.

FIG. 5 describes an exemplary XML DTD for template data constraint language (TDCL) according to an embodiment of the invention.

FIG. 6 is an exemplary data range validation specification using TDCL according to an embodiment of the invention.

FIG. 7 is an exemplary co-occurrence data validation specification using TDCL according to an embodiment of the invention.

FIG. 8 is an exemplary automatic data calculation specification using TDCL according to an embodiment of the invention.

### DETAILED DESCRIPTION OF THE PREFERRED EMBODIMENTS

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

It should be noted that the invention is not limited to any particular software language described or implied in the figures. One of ordinary skill in the art will understand that a variety of alternative software languages may be used for implementation of the invention. It should also be understood that some components and items are illustrated and described as if they were hardware elements, as is common practice within the art. However, one of ordinary skill in the art, and based on a reading of the detailed description, would understand that in at least one embodiment, components in the method and system may be implemented in software or hardware.

Embodiments of the invention provide methods, systems, and a computer-usable medium storing computer-readable instructions for providing template data validation using logic constraint specifications. The invention is a modular framework and is deployed as software as an application program tangibly embodied on a program storage device. The application code for execution can reside on a plurality of different types of computer readable media known to those skilled in the art.

In one embodiment, the invention is deployed as a network-enabled framework and is accessed through a graphical user interface (GUI). The application resides on a server and is accessed via a browser such as Mozilla Firefox, Microsoft IE (Internet Explorer), or others, over a network or the Internet using Internet standards and scripting languages including HTML, dynamic HTML (DHTML), Microsoft VBScript (Visual Basic Scripting Edition), Jscript, ActiveX and Java. A user contacts a server hosting the application and requests information or resources. The server locates, and then sends the information to the browser which displays the results.

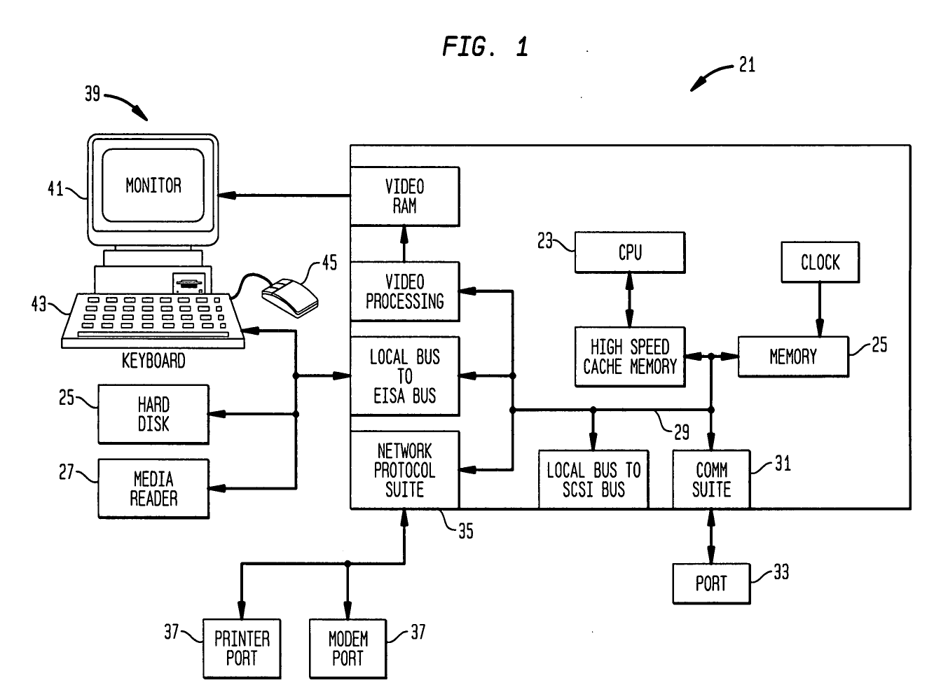

An embodiment of a computer 21 executing the instructions of an embodiment of the invention is shown in FIG. 1. A representative hardware environment is depicted which illustrates a typical hardware configuration of a computer. The computer 21 includes a CPU 23, memory 25, a reader 27 for reading computer executable instructions on computer readable media, a common communication bus 29, a communication suite 31 with external ports 33, a network protocol suite 35 with external ports 37 and a GUI 39.

The communication bus 29 allows bi-directional communication between the components of the computer 21. The communication suite 31 and external ports 33 allow bi-directional communication between the computer 21, other computers 21, and external compatible devices such as laptop computers and the like using communication protocols such as IEEE 1394 (FireWire or i.LINK), IEEE 802.3 (Ethernet), RS (Recommended Standard) 232, 422, 423, USB (Universal Serial Bus) and others.

The network protocol suite 35 and external ports 37 allow for the physical network connection and collection of protocols when communicating over a network. Protocols such as TCP/IP (Transmission Control Protocol/Internet Protocol) suite, IPX/SPX (Internetwork Packet eXchange/Sequential Packet exchange), SNA (Systems Network Architecture), and others. The TCP/IP suite includes IP (Internet Protocol), TCP (Transmission Control Protocol), ARP (Address Resolution Protocol), and HTTP (Hypertext Transfer Protocol). Each protocol within a network protocol suite has a specific function to support communication between computers coupled to a network. The GUI 39 includes a graphics display such as a CRT, fixed-pixel display or others 41, a key pad, keyboard or touchscreen 43 and pointing device 45 such as a mouse, trackball, optical pen or others to provide an easy-to-use, user interface for the invention.

The computer 21 can be a handheld device such as an Internet appliance, PDA (Personal Digital Assistant), tablet PC, Blackberry device or conventional personal computer such as a PC, Macintosh, or UNIX based workstation running their appropriate OS (Operating System) capable of communicating with a computer over wireline (guided) or wireless (unguided) communications media. The CPU 23 executes compatible instructions or software stored in the memory 25. Those skilled in the art will appreciate that the invention may also be practiced on platforms and operating systems other than those mentioned.

A communications network can be a single network or a combination of communications networks including any wireline, wireless, broadband, switched, packet or other type of network through which voice or data communications may be accomplished. Networks allow more than one user to work together and share resources with one another. Aside from distributed processing, a network provides centralized storage capability, security and access to resources.

Network architectures vary for LANs (Local Area Networks) and WANs (Wide Area Networks). Some examples of LAN network architectures include Ethernet, token ring, FDDI (Fiber Distributed Data Interface) and ATM (Asynchronous Transfer Mode). The capability of individual computers being linked together as a network is familiar to one skilled in the art.

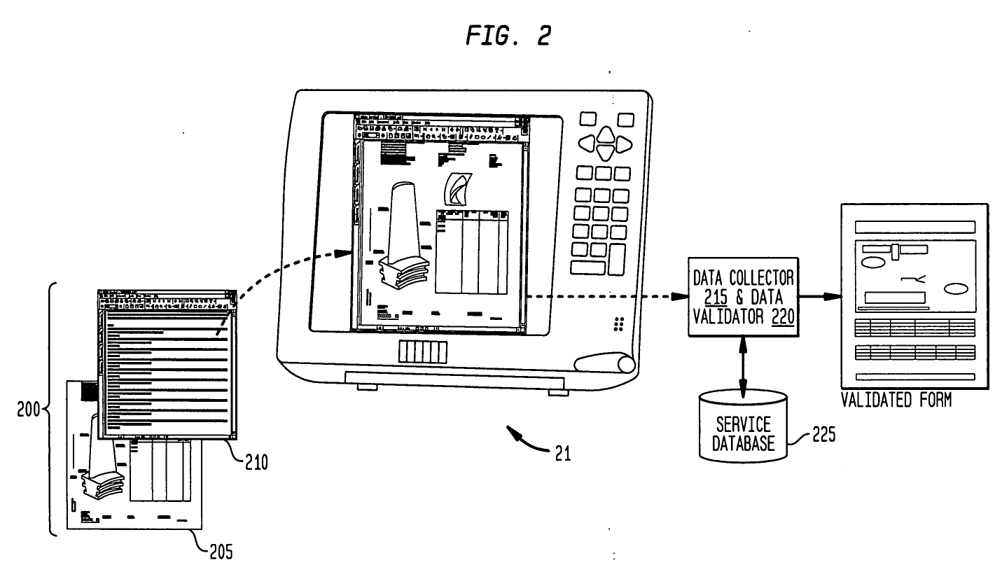

Shown in FIG. 2 is the template data validation framework of the various modules that comprise the invention as executed by a computer 21 and displayed using a browser. The invention framework allows effective validation of data being entered into an electronic form using a set of coupled modules comprising the invention. The modules include a form 200 comprising a template (bottom) layer 205 and a logical constraint specification (top) layer 210 written in template data constraint language (TDCL), a data collector 215 and validator 220 engine, and a service database 225. A form 200 can be tailored to any business application or commercial need. The service database 225 stores a plurality of forms 200 along with predetermined data for pre-loading the plurality of form constraint specification layers 210 depending on a specific application. Pre-loaded data for static quantities and for defining variables are downloaded with the form 200. The service database 225 also stores the data collector 215 and validator 220 engine for downloading. The service database 225 can be part of the user's computer 21 (not shown) or located remotely (shown) on a network server.

The template layer 205 may be an Adobe portable document format (PDF), HTML, XML, or other type of form image. The template layer 205 in conjunction with a constraint layer 210 validates data entered by a user during data collection using the accompanying data collector 215 and validator 220 engine.

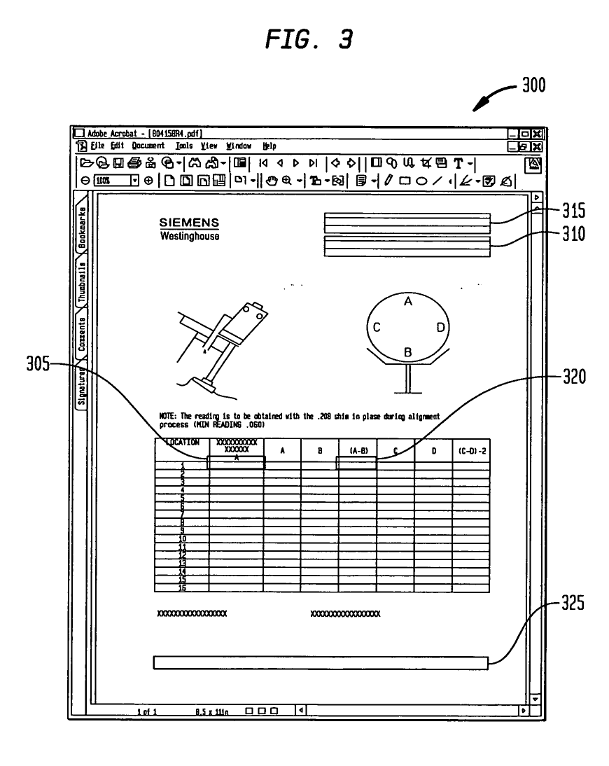

Shown in FIG. 3 is a form template layer in view 300. Typical form 300 data constraints may include static data such as type, range, etc. 305, dynamic data—co-occurrence or valued-dependent data 310, system values such as dates, etc., pre-determined/pre-populated data 315, calculated data—data calculated on-the-fly based on other field data 320, and digital signatures 325. Static 305, dynamic 310 and pre-populated 315 data are for particular applications or for particular machine/part types. One “smart form” 300 may be used for a plurality of different applications. For example, by specifying a unique form identifier when downloading a form from the service database 225 to a user's browser, different calculations and/or pre-populated data specific to that identifier are included in the constraint logic specification for the downloaded form.

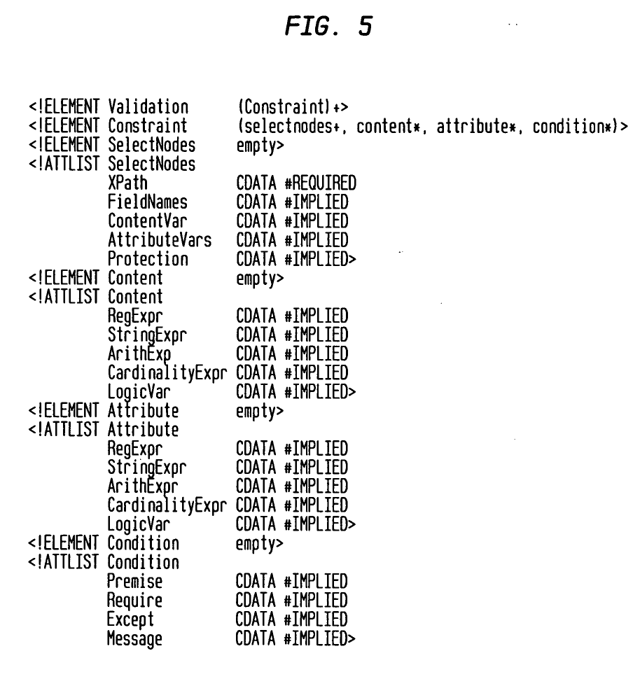

TDCL is a formal specification language developed for the invention and used to describe data integrity, logical data constraints, and data calculations. The XML DTD of TDCL is shown in FIG. 5.

The logical constraint specifications are a sequence of data constraints of content and element attributes in XML for constraining form data fields. The root element of a constraint specification is Validation. For each constraint description, there are four additional elements: SelectNodes, Content, Attribute, and Condition.

SelectNodes specifies the current context variables and fields where there are constraints. There can be multiple SelectNodes in one constraint for specifying dependent or co-occurrence (depending on constant value) constraints by sharing the variables to express the constraints. SelectNodes uses the following properties: XPath, FieldNames, ContentVar, AttributeVars, and Protection in developing a constraint specification.

XPath is used for describing the context of selected form fields based on the standard XML addressing mechanism XPath. FieldNames is used for alternatively describing selected form field context using field name conventions. The transparent logical constraint 210 overlay can access data entered on the template 205 either by fieldname (FieldNames), or by using form coordinates (XPath). ContentVar is used for declaring the content variable of currently selected XPath content. AttributeVars is used for declaring the attribute variables of currently selected XPath content. Both Content and Attribute variables provide mechanisms for specifying dependent constraints since variables can be shared by the same names to express the dependency. Protection is used for declaring a current protection mode for SelectNodes. Protection modes can be read-only, rewrite (default mode), and write-once (for digital signature).

The Content and Attribute elements are used to express the logical constraints under the context of current SelectNodes. Both Content and Attribute elements have the following properties to specify the combination of desired constraints.

StringExpr is used for specifying the string type, or comparison expression, of constraints in the syntax “X##OP##Y” for string comparison. “OP” are comparison operators such as EQ (equal), LE (less than or equal to), LT (less than), GT (greater than), GE (greater than or equal to), and IN (string inside). RegExpr is used to describe the data type constraints of fields, namely, what is a particular pattern of a string. For example, a Social Security Number is comprised only of 9 digits—no alpha characters. CardinalityExpr is used for the assertion of number of nodes under the current context, or length. ArithExpr is used to declare the attribute variables for current selected XPath content. Both Content and Attribute variables provide mechanisms for specifying dependent constraints. LogicVar is used to declare a logical variable name for each content or attribute constraint element.

Condition is used to specify a Boolean expression comprised of logical variables. A plurality of Conditions may exist in one constraint element. The Condition element has three properties: Premise for logical premise, Require for logical “and,” and Except for logical “not.” Multiple conditions equate to a logical “or.” In this construct, the Condition element can express all Boolean operators. For example, the following two Condition elements

| | |
|---|---|
| <Condition | Premise= “Z” Require = “X Y” Except=“D Y” /> |
| <Condition | Require = “A” Except =“B” /> |

denote the Boolean expression
˜z or ((x and y) and (˜d and ˜y))) or (a and ˜b). (1)

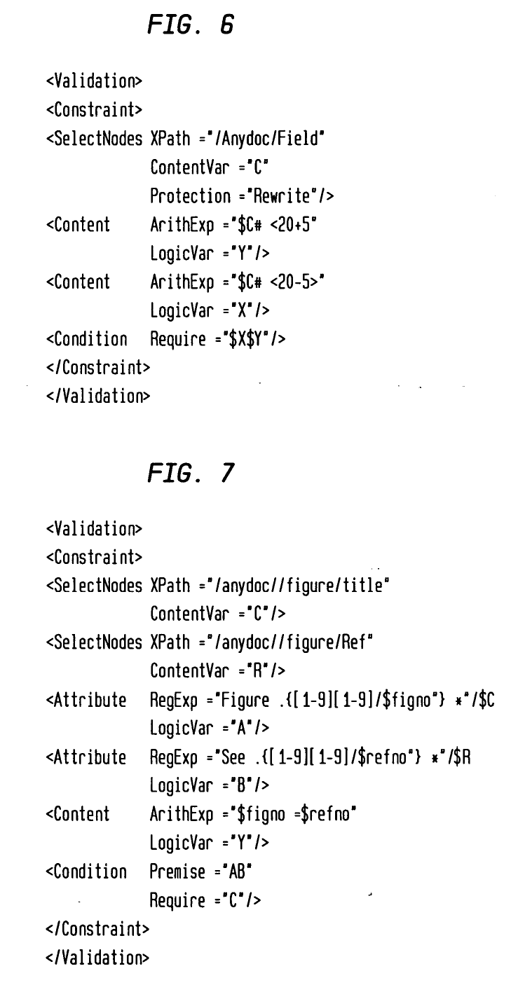

Examples illustrating various constraint specifications are shown in FIGS. 6, 7 and 8.

FIG. 6 shows a logical constraint specification example for data range validation using TDCL of the invention. The value of Field, denoted by $C#, is less than 25, but greater than 15.

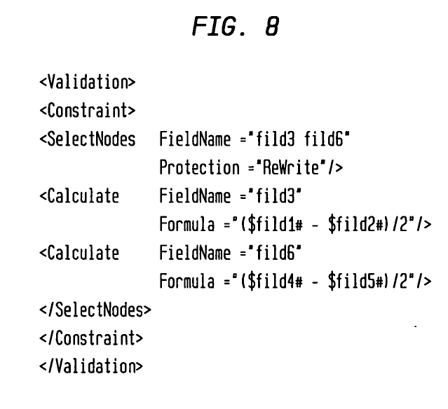

FIG. 7 shows a logical constraint specification example for co-occurrence data validation. Inside all figures, if there is figure number mentioned in the title, then all data entry for figure reference places require using the same number inside the same figure. FIG. 8 shows a logical constraint specification example for automatic data calculation. The value offild3 is automatically calculated based on the values offild1 and fild2. fild3 is the average of the difference between fild1 and fild2. The value offild6 is calculated by using the values offild4 and fild5.

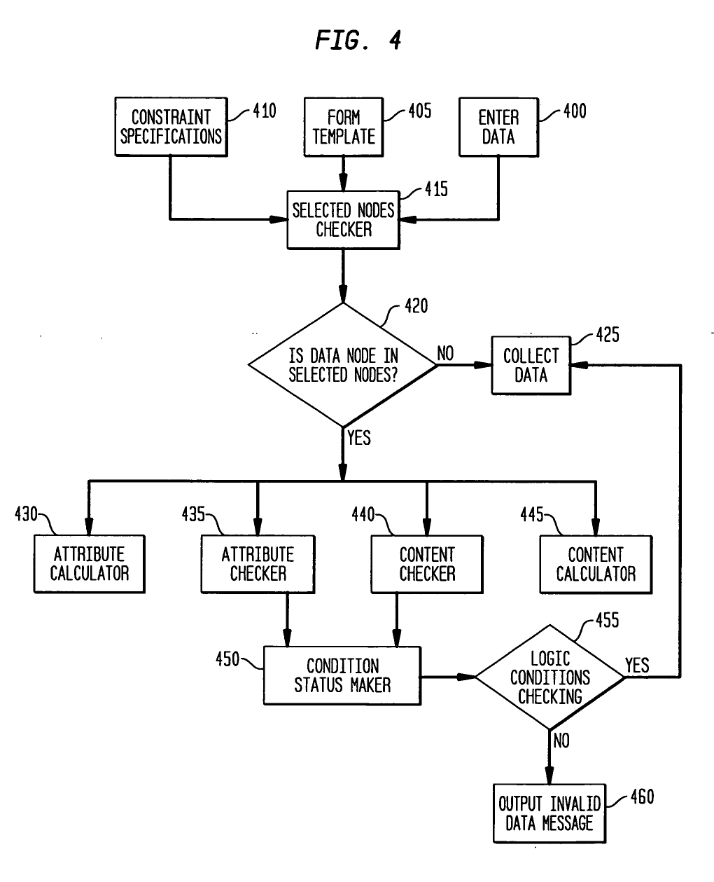

Returning to FIGS. 2 and 3, and referring to a flowchart of a method for template data validation according to an embodiment of the invention shown in FIG. 4, a user downloads a form 300 from the service database 225 to a computer 21 for display using a browser. With the form 300 in view, the user enters data (step 400). As described above, the template layer 205 (step 405), the logical constraint specification layer 210 (step 410), and the data collector 215 and validator 220 engine constitute the download. The data collector 215 and validator 220 engine may be downloaded once and remain resident on a user's computer for future use. As data is entered onto data entry areas or fields of the form 300, the data collector 215 and validator 220 engine performs TDCL interpretation (step 415), data collection, on-the-fly data validation, and displays any resultant warning message if invalid data has been entered.

The data validator 220 is invoked by the data collector 215 to perform the progressive data validation process during data entry. The data validator 220 first checks if there is a constraint associated with a field where data has been entered (step 420). The check is performed while a user is entering data. If there is no constraint for the current field, the data collector 215 performs a normal collection function for the data (step 425). If a constraint is associated with the field under entry, the data validator 220 (step 420) invokes operators (steps 430, 435, 440, 445) based on the logical constraint specification.

The operators include an attribute calculator (step 430) for automatic calculating a value into a field using a form field attribute formula contained in the constraint specification 210, an attribute checker (step 435) for checking the entered value of the field using a form field, a content checker (step 440) for checking the entered value of the field using form field content constraints, and a content calculator (step 445) for automatic calculating a value into a field using a form field content formula in the constraint specification 210.

For each checker (steps 435, 440), a logical variable holds the value of the checking result. A condition status maker (step 450) combines the logical variables based on the conditions into a Boolean expression for validation. If the resulting Boolean expression is true with the data that has been entered (step 455), the data collector 215 will perform data entry (step 425). If the resulting Boolean expression is false (if a constraint violation is found), the data validator 220 will produce a warning message displaying the error and what data should have been entered based on the descriptions in the condition elements (step 460). The process repeats for each data entry area or field until all data entry is complete and correct. Afterwards, the data collector 215 can store or forward the completed form to an agent for further processing.

Although the invention herein has been described with reference to particular embodiments, it is to be understood that these embodiments are merely illustrative of the principles and applications of the present invention. Moreover, although hardware or software have been used to implement certain functions described in the present invention, it will be understood by those skilled in the art that such functions may be performed using hardware, software or a combination of hardware and software. It is therefore to be understood that numerous modifications may be made to the illustrative embodiments and that other arrangements may be devised without departing from the spirit and scope of the present invention as defined by the appended claims.

What is claimed is:

1. A method for dynamically and progressively validating input data comprising:
receiving input data via an input form having an associated logical constraint specification;
determining if said input data is associated with one or more constraints within said logical constraint specification;
invoking one or more operators on said input data to generate one or more logical variables based on said logical constraint specification;
combining said one or more logical variables based on said logical constraint specification into a single logical expression for validation; and
validating said input data based on said single logical expression.

2. The method according to claim 1 wherein determining if the input data is associated with one or more constraints within said logical constraint specification comprises selecting one or more data collection fields in the input form.

3. The method according to claim 1 wherein invoking one or more operators on the input data to generate one or more logical variables based on said logical constraint specification comprises performing one or more check operations on the input data.

4. The method according to claim 3 wherein said operators are selected from one or more of an attribute checker and a content checker.

5. The method according to claim 1 wherein combining said one or more logical variables based on said logical constraint specification into a single logical expression for validation comprises assigning a logical variable corresponding to the input data based on said relevant logical constraint.

6. The method according to claim 1 wherein validating the input data based on said single logical expression comprises displaying a warning message if said input data does not meet said constraints.

7. A method comprising:
providing a plurality of data fields for input, one or more of said data fields having an associated constraint;
determining if a particular constraint is associated with said current data field;
performing one or more operations on said current data field based on said particular constraint associated with said current data field; and
validating said current data field based on said particular constraint associated with said current data field.

8. A system for dynamically and progressively collecting and validating electronic form input data comprising:
a template having data entry areas;
a logical constraint specification having at least one data constraint for at least one of said template data entry areas; and
a data collector and validator engine that performs data validation for data entered in said template data entry areas.

9. The system according to claim 8 wherein said template, logical constraint specification overlay and data collector and validator engine are downloaded from a server to a client.

10. The system according to claim 8 wherein said template is selected from one of an Adobe portable document format (PDF), HTML or XML form image.

11. The system according to claim 10 wherein said data validator is invoked by said data collector during data entries into said template.

12. The system according to claim 11 wherein each said constraint is described in XML template data constraint language and contains a SelectNodes, Content, Attribute, and Condition element.

13. The system according to claim 12 wherein said SelectNodes specifies current context variables and fields using XPath, FieldNames, ContentVar, AttributeVars and Protection properties in said constraint.

14. The system according to claim 12 wherein said Content and Attribute elements are used to express logical constraints under the context of current SelectNodes.

15. The system according to claim 12 wherein said Condition element is used to specify a Boolean expression based on declared logical variables.

16. The system according to claim 15 wherein a plurality of Condition elements are part of one constraint, each Condition element having Premise, Require and Except properties.

17. A method for performing data validation in a client-side form comprising:
generating an XML form having a plurality of data entry fields for client-side input;
receiving client-side input data in one or more of said plurality of data entry fields;
progressively evaluating at least a portion of said client-side input data received in one or more of said data entry fields against a logical constraint specification; and
validating said input data based on said logical constraint specification.
